(19) United States
(12) Patent Application Publication
(10) Pub. No.: US 2021/0385305 A1
(43) Pub. Date: Dec. 9, 2021

(54) COMMUNICATION DEVICE WITH CONNECTION DETECTION

(71) Applicants: Buerkert Werke GmbH & Co. KG, Ingelfingen (DE); Burkert S.A.S., Triembach-au-Val (FR)

(72) Inventors: Mohamad Said ABDUL KADER, Ingelfingen (DE); Benjamin FERRY, Ingelfingen (DE); Alain ELSAESSER, Ingelfingen (DE)

(21) Appl. No.: 17/339,399

(22) Filed: Jun. 4, 2021

(30) Foreign Application Priority Data
Jun. 9, 2020 (FR) 2006034

(51) Int. Cl. H04L 29/06

(52) U.S. Cl. CPC H04L 69/08

(57) ABSTRACT

The present invention relates to a communication device. It includes a connection unit having a plurality of input contacts. At least two input contacts are coupled to a network. The input contacts are usable according to a first network protocol and a second network protocol different from the first. The device also includes a detection module which is configured such that a use of the connection unit according to the first or the second network protocol can be identified based on input signals of at least a first and a second input contact. The device further includes a function module which can be configured based on the network protocol identified by the detection module such that a communication of the communication device according to the identified network protocol can be enabled by the function module.

### FIELD OF THE INVENTION

The invention relates to a communication device having a connection detection, to a field device having a communication device, and to a method.

### TECHNICAL BACKGROUND

In automation technology, standardized connectors are usually used for communication between different components by means of field buses, industrial or real-time Ethernet or other wired or wireless networks. Such connectors usually include a certain number of input contacts. Depending on the assignment, such connectors may then be usable based on different communication standards and can thus permit communication with communication systems of different types.

However, it must then be ensured that the connector also uses the correct communication protocol such that applied and/or provided voltages and/or currents are processed correctly. In particular, it must be prevented that the connected communication systems or also the electronic components for which the connector permits communication, suffer damage which may result from an inappropriate signal processing. To this end, the user usually selects the appropriate communication protocol on the hardware or software side, on the basis of which the assignment of the input contacts is then determined.

If this effort is to be eliminated, several network boards are necessary for field devices according to the prior art to be able to provide communication according to the different communication protocols.

### DESCRIPTION

It is the object of the invention to provide a communication device, a field device and a method in which the drawbacks of the prior art are eliminated or at least reduced. Further objects will become apparent from the description below.

The object is achieved by the subject matters of the independent claims. Advantageous designs can be found in the dependent claims. The advantages and preferred designs cited with respect to the communication device described below are to be applied analogously to the method and vice versa. The method of detecting a network protocol is used in particular for operating the communication device described below.

A communication device is provided, among other things.

The communication device comprises a connection unit having a plurality of input contacts. At least two input contacts are coupled to a network. The input contacts are usable according to a first network protocol and a second network protocol different from the first. This means that the input contacts are usable according to the first and the second network protocol in accordance with different input wirings.

The communication device also comprises a detection module. The detection module is configured such that a use of the connection unit according to the first or second network protocol can be identified based on input signals of at least a first and a second input contact.

In addition, the communication device comprises a function module which is configurable based on the network protocol identified by the detection module such that a communication of the communication device with the coupled network according to the identified network protocol can be enabled by the function module. In other words, the detection module is configured to determine the network protocol used by the network which is coupled to the input contacts. The function module can then be configured according to the determined network protocol. The function module can then enable communication of the communication device according to the identified network protocol. The communication may be enabled depending on the configuration of the function module being verified by a comparison with the network protocol identified by the detection module. It can then be ensured that the communication device is not used according to an incorrect network protocol. Damage to the communication device or the connected network can then be prevented.

The detection module may be configured to perform suitable sensing functions to be able to use them to sense various values, states, amplitudes, strengths, or intensities of the input signals.

The detection module may be configured to identify the use of the connection unit according to the first or the second network protocol based on voltage measurements for the first and the second input contact. Voltage measurements can be made in a very reliable way. The first and the second network protocol may be such that the voltage amplitudes on at least two input contacts differ from each other such that, based on the sensed voltage levels (individually or also in combination), a reliable statement can be made about which network protocol is used by the network coupled to the connection unit. In particular, the voltage measurements at the first and the second input contact may be complementary to each other. In other words, a first voltage measurement at the first input contact may be verifiable by a corresponding second voltage measurement at the second input contact.

The communication device may also comprise a processing module. The processing module may be configured to configure the function module based on the identified network protocol according to the identified network protocol. Subsequently, the communication device may then be enabled for communication according to the identified network protocol. In this regard, the processing module may be configured to receive a result of the detection module and perform a configuration of the function module based on the result. The processing module may also perform a monitoring function to verify that the function module is configured according to the identified network protocol before enabling communication of the communication device with the network.

In particular, the detection of the network protocol and the configuration of the function module, as well as the subsequent release of the communication may be automated. This means that no user input must be necessary to detect the network protocol used by the coupled network and to configure the function module accordingly. For this purpose, corresponding data processing units, processors, circuits, or the like may be comprised by the individual modules and/or the communication device, in particular the processing module. In this respect, the communication device may be configured to automatically detect the connected network with the corresponding network protocol.

The detection module may comprise protection means. Based on the protection means, damage to the detection module and the network coupled to the input contacts may be prevented. In particular, the protection means may include protection circuits, such as overload circuits and safety circuits, for example.

At least three input contacts may also be coupled to the network. The detection module may then be configured to identify the use of the connection unit according to the first or second network protocol based on voltage measurements for the first and the second input contact and based on the presence or absence of an input signal for a third input contact. The detection of the network protocol may then include the consideration of an additional measuring signal, thus increasing the security of the detection mechanism.

At least four input contacts may also be coupled to the network. The detection module may then be configured to identify the use of the connection unit according to the first or the second network protocol based on voltage measurements for the first and the second input contact based on the presence or absence of an input signal for a third input contact, and based on a voltage measurement for a fourth input contact. Therefore, the security of the detection mechanism of the network protocol can again be increased.

The connection unit may comprise a five-pole M12 connector or a five-pole M12 female connector. The M12 standard (DIN EN 61076-2-101:2013-01; VDE 0687-76-2-101:2013-01) is a widely used standard for communication connections in automation technology, for sensors, actuators and field buses and in network technology. Such couplings are robust as circular connectors (if necessary pluggable or screwable) and can be used for many application purposes. The couplings can be protected according to IP65, IP67, IP68 and/or IP69K.

The first network protocol can comprise I/O link and the second network protocol can comprise CAN. These network protocols are widely used. However, the contacts of the corresponding couplings have different assignments. Thus, these two network protocols provide the ability to detect the network protocol used based on the contact assignment.

Once configured, a function module may be reconfigurable according to the first or the second network protocol after disconnection of a coupling between the connection unit and the network. This means that the function module is not fixed to the corresponding network protocol after initial configuration. Rather, the communication device is restored to the original state after disconnection from the network. Thus, the function module is subsequently again adapted to be configured according to both network protocols.

A method of detecting a network protocol used by a network coupled to a communication device is also provided. To this end, the network is coupled to a plurality of input contacts of the communication device.

The method comprises the sensing of a voltage amplitude for at least a first and a second input contact.

The method further comprises the identification of the network protocol used by the network based on the sensed voltage amplitudes.

The method also comprises the configuration of a function module according to the identified network protocol such that a communication of the communication device with the coupled network according to the identified network protocol can be enabled by the function module.

According to further aspect, a field device is also provided. The field device comprises a communication device as previously described. The detection module and the function module may be comprised by the field device. The connection unit may be external to the field device or may be considered external. The input contacts of the connection unit are coupled to the detection module of the field device via corresponding connection lines. The field device may be configured to communicate with the network after the function module has been configured based on the connection unit.

The field device may also comprise a processing module.

The field device may also comprise a communication device configured to detect a network based on the previously described method, in particular a network protocol used by the network.

In the present case, field device means in particular a technical device in the field of automation technology. Field devices include actuators for influencing process variables, sensors for detecting process variables and other process-related devices which supply or process relevant information. Actuators include, for example, final control elements, (process) valves, engines and pumps. Sensors include, for example, flow meters, pressure gauges, temperature measuring devices and pH sensors. Furthermore, field devices also include process-related devices which are used for communication and control, for example gateways, remote I/Os, linking devices, wired-program controllers, valve controllers, control heads, and stored-program controllers.

In particular, field devices can communicate with other field devices, gateways, or higher-level devices via field buses, industrial or real-time Ethernet, or other wired or wireless networks.

### DESCRIPTION OF THE FIGURES

In the following, the features and aspects are explained in more detail using example embodiments and with reference to the figures, in which

FIG. 1 shows a simplified schematic representation of an M12 circular connector, and

FIG. 2 shows a simplified schematic representation of a field device having a communication device.

### DETAILED DESCRIPTION

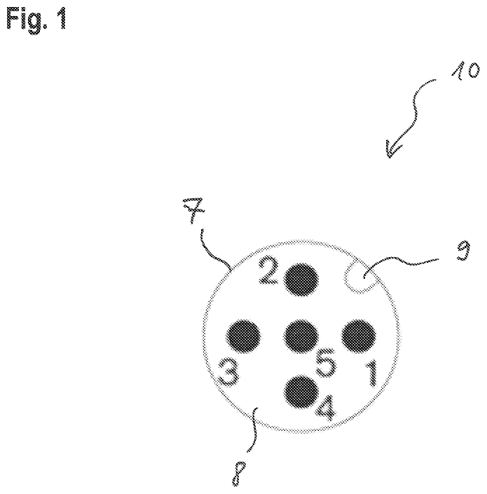

FIG. 1 shows a simplified schematic representation of an M12 circular connector 10.

In the present case, the M12 circular connector 10 has five poles. In the present case, the M12 circular connector 10 has five pins 1-5, a housing 7, a filler material 8 and a plug-in coding 9. The pins 1-5 are surrounded by the housing 7 and electrically insulated therefrom by means of the filler material 8. Regularly, an M12 circular connector 10 can be manufactured by an injection molding method. The plug-in coding 9 prevents false plugging, as the corresponding female connector has a corresponding plug-in coding.

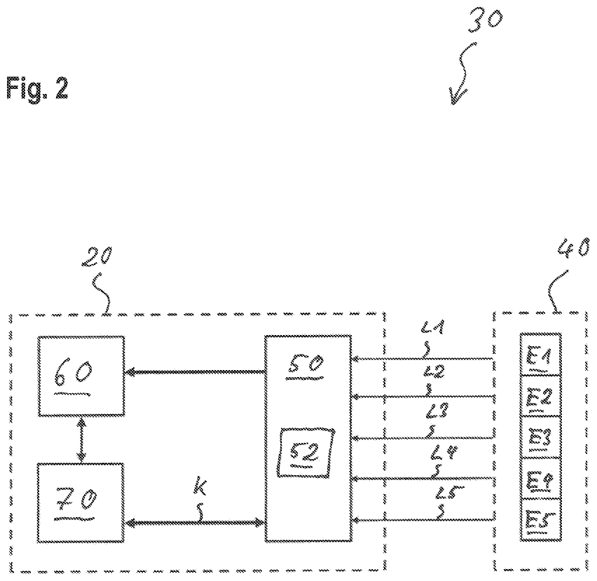

FIG. 2 shows a simplified schematic representation of a field device 20 having a communication device 30.

The communication device 30 comprises a connection unit 40, the detection module 50, the processing module 60 and the function module 70. The detection module 50, the processing module 60 and the function module 70 are comprised by the field device 20. On the other hand, the connection unit 40 is external to the field device 20. The input contacts E1-E5 of the connection unit 40 are coupled to the field device 20 or the detection module 50 via the connection lines L1-L5.

The detection module 50 comprises protection means (not shown), for example protection circuits for the individual lines L1-L5 and the input contacts E1-E5 coupled thereto. However, the protection means also protect the detection module 50 itself and the remaining components of the communication device 30 as well as the field device 20 from damage.

As soon as a network is connected to the connection unit 40 (i.e. to the input contacts E1-E5), the detection module 50 detects that “something” has been connected via the lines L1-L5. The detection module 50 now evaluates the lines L1-L5 and generates a sensing result 52. The sensing result 52 is transmitted or provided to the processing module 60. Based on the sensing result 52, the processing module 60 configures the function module 70 for the detected network and enables communication K with the detected network for the field device 20.

When the network is disconnected from the input contacts E1 to E5, the communication K is interrupted and the detection module 50 again “waits” for a network to be connected to the input contacts E1-E5. Accordingly, the function module 70 is also reconfigurable based on a new sensing result 52.

The mode of operation of the detection module 50 is explained on the basis of the connection to a CAN network or I/O link on the five-pole M12 circular connector 10. The lines L1-L5 are substantially tested in a suitable sequence in which electrical measurements are taken. Protection circuits of the detection module 50 prevent damage to both the detection module 50 and the network under test. Based on known characteristics of I/O-Link and CAN, it is determined whether the connected network is I/O-Link or CAN. According to I/O-Link and CAN, the pin assignments of the M12 circular connector 10 are different, as can be seen from the following table.

TABLE 1
Pin assignments of an M12-circular connector and the input
contacts of the connection unit for I/O-Link and CAN

| Input contact | M12 Pin | I/O Link | CAN |
|---|---|---|---|
| E1 | 1 | V+ | shield |
| E2 | 2 | I/O | V+ |
| E3 | 3 | GND | GND |
| E4 | 4 | C/Q | CAN_H |
| E5 | 5 | not used | CAN_L |

As the input contacts E1-E5 are coupled to the associated pins 1-5 via connection lines L1-L5, it can be concluded based on the different pin assignment which network protocol is used by the network coupled to the communication device 30.

After connection of a network to the five-pole M12 circular connector 10 on the input contacts E1-E5 of the connection unit 40, the detection module 50 starts its detection procedure.

First, a voltage measurement is performed across the connection lines L1 and L2. Based on the amplitude of the measured voltage, it can be respectively sensed what is coupled to the input contacts E1 and E2:

E1: V+ or shield

E2: I/O or V+

This means that the respectively sensed amplitude of the voltage is compared at least in terms of amount with a predetermined expectation value of the amplitude for the respective input contact and the respective configuration. If the measured amplitude corresponds to the respective expectation value within predetermined limits, the sensing of a specific configuration is positively determined. The detection module 50 can already identify the used network protocol based on these voltage measurements.

Optionally, the detection module 50 may then perform further voltage measurements to verify the sensing result 52 (sensed network protocol) found. For example, a voltage measurement can be performed via the connection line L5, and it can be sensed whether a voltage signal is present at all at the input contact E5:

E5: “something” or “nothing”

The detection that “something” is present may in particular require that the amplitude of the applied voltage exceeds a predetermined threshold in terms of amount. False sensings based on an electronic noise may thus be excluded.

In addition, a voltage measurement may also be performed via the connection line L4 at the input contact E4. For the input contact E4, the expected amplitude of the voltage is “near CAN_H” (CAN-high) for CAN and “something else” for I/O Link:

E4: “voltage near CAN” or “something else”

For this measurement, the sensing of a specific network protocol based on the voltage measurement may depend on whether the measured amplitude of the voltage differs by more than a minimum difference in terms of amount from the expected value for “CAN_H”.

The aforementioned sequence of the voltage measurements constitutes a particularly advantageous sequence. However, it is in principle also possible to deviate therefrom.

The detection module 50 may also be configured to perform the respective measurements multiple times to increase the security of the detection mechanism.

The sensing result 52 specifies the identified network protocol for each voltage measurement according to one of the connection lines L1 to L5 by type, i.e. respectively grouped in a line-dependent manner. The detection of an identified network protocol may then depend on the sensing result 52 listing for all tested connection lines/input contacts a uniform result for the found network protocol, i.e. having respectively identified either I/O Link or CAN for all tested input contacts. The sensing result 52 can be rejected if the sensing result 52 has found different network protocols for different input contacts. In this case, the detection module 50 can be configured to restart the detection.

After an unambiguous detection of the network protocol used by the coupled network, the processing module 60 configures the function module 70 for the identified protocol using the sensing result 52. The communication K of the communication device 30 with the coupled network is then enabled. The release may depend on the function module 70 positively confirming the configuration according to the identified network protocol, for example with respect to the processing module 60.

Once the network is disconnected from the contact points E1-E5, the communication K is interrupted, and the detection module 50 “waits” again for the connection of a network to the contact points E1-E5. The detection mechanism can then start again.

1. A communication device comprising:
a connection unit having a plurality of input contacts, wherein at least two input contacts are coupled to a network, and wherein the input contacts are usable according to a first network protocol and a second network protocol different from the first,
a detection module configured such that a use of the connection unit according to the first or the second network protocol can be identified based on input signals of at least a first and a second input contact, and
a function module which can be configured based on the network protocol identified by the detection module such that a communication of the communication device with the coupled network according to the identified network protocol can be enabled by the function module.

2. The communication device according to claim 1, wherein the detection module is configured to identify the use of the connection unit according to the first or the second network protocol based on voltage measurements for the first and the second input contact.

3. The communication device according to claim 1, further comprising a processing module, wherein the processing module configures the function module based on the identified network protocol according to the identified network protocol, and wherein subsequently, the communication device is enabled for communication according to the identified network protocol.

4. The communication device according to claim 1, wherein the detection module comprises protection means, wherein based on the protection means, damage to the detection module and the network coupled to the input contacts is prevented.

5. The communication device according to claim 1, wherein at least three input contacts are coupled to the network, and wherein the detection module is configured to identify the use of the connection unit according to the first or the second network protocol based on voltage measurements for the first and the second input contact and based on a presence or absence of an input signal for a third input contact.

6. The communication device according to claim 1, wherein at least four input contacts are coupled to the network, and wherein the detection module is configured to identify the use of the connection unit according to the first or the second network protocol based on voltage measurements for the first and the second input contact based on a presence or absence of an input signal for a third input contact, and based on a voltage measurement for a fourth input contact.

7. The communication device according to claim 1, wherein the connection unit comprises a five-pole M12 circular connector or a five-pole M12 female connector.

8. The communication device according to claim 1, wherein the first network protocol comprises I/O link and the second network protocol comprises CAN.

9. The communication device according to claim 1, wherein once configured, a function module is reconfigurable according to the first or second network protocol after disconnection of a coupling between the connection unit and the network.

10. A method of detecting a network protocol used by a network coupled to a communication device, the network being coupled to a plurality of input contacts of the communication device, the method comprising:
a) sensing a voltage amplitude for at least a first and a second input contact,
b) identifying the network protocol used by the network based on the sensed voltage amplitudes,
c) configuring a function module according to the identified network protocol such that a communication of the communication device with the coupled network according to the identified network protocol can be enabled by the function module.

11. A field device comprising a communication device according to claim 1, wherein the field device comprises the detection module and the function module, wherein the field device has a plurality of connection lines by means of which it is coupled to the input contacts of the connection unit, and wherein the field device is configured to communicate with the network based on the configured function module.

12. A field device comprising a communication device configured to detect a network based on the method according to claim 10.
